(19) United States
(12) Patent Application Publication
(10) Pub. No.: US 2026/0103006 A1
(43) Pub. Date: Apr. 16, 2026

(54) LIQUID DISCHARGE APPARATUS

(71) Applicant: SEIKO EPSON CORPORATION, Tokyo (JP)

(72) Inventor: Shoma KUDO, Shiojiri-shi (JP)

(73) Assignee: SEIKO EPSON CORPORATION, Tokyo (JP)

(21) Appl. No.: 19/340,329

(22) Filed: Sep. 25, 2025

(30) Foreign Application Priority Data
Sep. 26, 2024 (JP) 2024-167226

(51) Int. Cl. B41J 2/175; B41J 3/44; B41J 13/10; B41J 29/13

(52) U.S. Cl. CPC B41J 2/17566; B41J 2/17509; B41J 2/17523; B41J 3/44; B41J 13/103; B41J 13/106; B41J 29/13; B41J 2002/17573

(57) ABSTRACT

An operation section is disposed on one side in a width direction intersecting a vertical direction with respect to a vertical branch line extending along the vertical direction in front view. A liquid accommodation section, a liquid replenishment port, and a liquid visual recognition section are disposed on the other side in the width direction. The liquid accommodation section is provided at a position aligned with the operation section. The liquid visual recognition section is provided in a range below the lower end section of the operation section in the vertical direction. The cover is provided to straddle the vertical branch line and is rotatable about an axis along the width direction. The cover grip section is provided on at least one of a first side surface side on the one side in the width direction, and a second side surface on the other side in the width direction.

The present application is based on, and claims priority from JP Application Serial Number 2024-167226, filed Sep. 26, 2024, the disclosure of which is hereby incorporated by reference herein in its entirety.

### BACKGROUND

### 1. Technical Field

The present disclosure relates to a liquid discharge apparatus.

### 2. Related Art

For example, as disclosed in JP-A-2019-81276, a liquid ejecting apparatus that ejects liquid is disclosed as an example of a liquid discharge apparatus. An operation panel section and a front cover are provided on a front surface of the liquid discharge apparatus. The operation panel section is positioned on the upper side with respect to the front cover. As a result, in front view, a horizontal branch line is provided between the lower end section of the operation panel section and the upper end section of the front cover.

However, in such a liquid discharge apparatus, there is a concern that the quality of the appearance of the liquid discharge apparatus on the front surface may deteriorate. Therefore, it is desired to improve the quality of the appearance of the liquid discharge apparatus on the front surface.

### SUMMARY

According to an aspect of the present disclosure, there is provided a liquid discharge apparatus including a liquid accommodation section that accommodates liquid to be discharged onto a medium, a liquid replenishment port for replenishing liquid into the liquid accommodation section, a liquid visual recognition section that visually recognizes a remaining amount of the liquid accommodated in the liquid accommodation section, an operation section that is operable by a user, a discharge port for discharging the medium onto which the liquid is discharged, a cover configured to open and close the discharge port, and a cover grip section configured to grip the cover, in which the operation section is disposed on one side in a width direction intersecting a vertical direction with respect to a vertical branch line extending along the vertical direction in front view, the liquid accommodation section, the liquid replenishment port, and the liquid visual recognition section are disposed on another side in the width direction with respect to the vertical branch line in front view, the liquid accommodation section is provided at a position aligned with the operation section in the width direction, the liquid replenishment port is provided in a range between an upper end section and a lower end section of the operation section in the vertical direction, the liquid visual recognition section is provided in a range below the lower end section of the operation section in the vertical direction, the cover is provided to straddle the vertical branch line and is rotatable about an axis along the width direction, and the cover grip section is provided on at least one of a first side surface side on the one side in the width direction with respect to the vertical branch line, and a second side surface on the other side in the width direction with respect to the vertical branch line.

According to an aspect of the present disclosure, there is provided a liquid discharge apparatus including a mounting section that mounts a liquid accommodation container for accommodating liquid to be discharged onto a medium, a liquid visual recognition section that visually recognizes a remaining amount of the liquid accommodated in the liquid accommodation container, an operation section that is operable by a user, a discharge port for discharging the medium onto which the liquid is discharged, a cover configured to open and close the discharge port, and a cover grip section configured to grip the cover, in which the operation section is disposed on one side in a width direction intersecting a vertical direction with respect to a vertical branch line extending along the vertical direction in front view, when the liquid accommodation container is mounted on the mounting section, the liquid accommodation container and the liquid visual recognition section are disposed on another side in the width direction with respect to the vertical branch line in front view, when the liquid accommodation container is mounted on the mounting section, the liquid accommodation container is provided at a position aligned with the operation section in the width direction, the liquid visual recognition section is provided in a range below a lower end section of the operation section in the vertical direction, the cover is provided to straddle the vertical branch line and is rotatable about an axis along the width direction, and the cover grip section is provided on at least one of a first side surface side on the one side in the width direction with respect to the vertical branch line, and a second side surface on the other side in the width direction with respect to the vertical branch line.

### BRIEF DESCRIPTION OF THE DRAWINGS

FIG. 1 is a perspective view illustrating a liquid discharge apparatus according to a first embodiment.

FIG. 2 is a perspective view illustrating the liquid discharge apparatus according to the first embodiment.

FIG. 3 is a front view illustrating the liquid discharge apparatus according to the first embodiment.

FIG. 4 is a front view illustrating the liquid discharge apparatus according to the first embodiment.

FIG. 5 is a front view illustrating a liquid discharge apparatus according to a second embodiment.

### DESCRIPTION OF EMBODIMENTS

### First Embodiment

Hereinafter, an embodiment of a liquid discharge apparatus will be described with reference to the accompanying drawings. In the following description, when the liquid discharge apparatus is installed on a horizontal surface, a direction intersecting a vertical direction Z is defined as a width direction X, and a direction intersecting the vertical direction Z and a width direction X is defined as a front-rear direction Y. One direction in the width direction X is referred to as a first width direction X1, and the other direction in the width direction X is referred to as a second width direction X2. One direction in the front-rear direction Y is referred to as a front side Y1, and the other direction in the front-rear direction Y is referred to as a rear side Y2. The downward direction in the vertical direction Z is referred to as a lower side Z1, and the upward direction in the vertical direction Z is referred to as an upper side Z2. The first width direction X1 corresponds to one example in the width direction X, and the second width direction X2 corresponds to the other example in the width direction X. A view in which the front side Y1 is directed to the rear side Y2 is simply referred to as a front view.

### Configuration of Liquid Discharge Apparatus 11

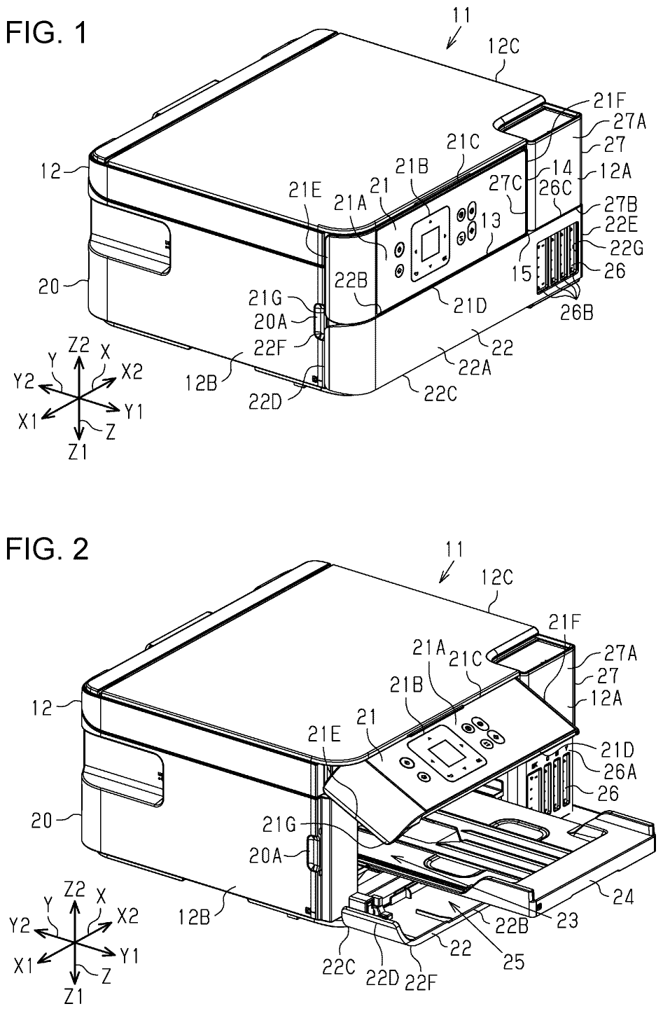

As illustrated in FIG. 1, a liquid discharge apparatus 11 is configured to perform printing on a medium by discharging liquid onto the medium. The liquid may contain, for example, ink. The liquid may have, for example, a plurality of types of colors. The liquid discharge apparatus 11 may be an ink jet printer.

The liquid discharge apparatus 11 includes a housing 12. The housing 12 is configured to accommodate various members that configure the liquid discharge apparatus 11. The housing 12 is configured as an exterior of the liquid discharge apparatus 11. The housing 12 may be supported by legs (not illustrated).

The housing 12 includes a front surface 12A. The front surface 12A is a surface of the housing 12 on the front side Y1. The housing 12 includes a first side surface 12B and a second side surface 12C. The first side surface 12B is a surface of the housing 12 in the first width direction X1. The second side surface 12C is a surface of the housing 12 in the second width direction X2.

A horizontal branch line 13 and a vertical branch line 14 are provided on the front surface 12A. The horizontal branch line 13 passes through a reference position 15 of the front surface 12A. The reference position 15 is provided at a position other than the end section of the front surface 12A. The horizontal branch line 13 extends along the width direction X. The horizontal branch line 13 extends from the reference position 15 in both the first width direction X1 and the second width direction X2. The horizontal branch line 13 may extend over the entire width of the front surface 12A. The horizontal branch line 13 is a line that branches the front surface 12A into a region on the upper side Z2 and a region on the lower side Z1.

The vertical branch line 14 passes through the reference position 15 of the front surface 12A. The vertical branch line 14 extends in the vertical direction Z. The vertical branch line 14 extends from the reference position 15 on the upper side Z2. The vertical branch line 14 is a line that branches the region on the front surface 12A on the upper side Z2 with respect to the horizontal branch line 13 into the region in the first width direction X1 and the region in the second width direction X2.

A virtual line obtained by extending the vertical branch line 14 along the vertical branch line 14 is a line that branches the front surface 12A into a region in the first width direction X1 and a region in the second width direction X2. Hereinafter, when the first width direction X1 side and the second width direction X2 side are respectively indicated by a virtual line, the first width direction X1 side and the second width direction X2 side may be simply indicated by the vertical branch line 14, respectively.

The housing 12 includes a housing main body 20. The housing main body 20 may constitute at least the first side surface 12B and the second side surface 12C. The housing main body 20 includes a recessed section 20A on the first side surface 12B. That is, the housing 12 includes the recessed section 20A. The recessed section 20A is provided on the extension line of the horizontal branch line 13.

The liquid discharge apparatus 11 includes an operation section 21. The operation section 21 includes a front surface 21A. The front surface 21A of the operation section 21 constitutes a part of the front surface 12A of the housing 12. The operation section 21 is disposed on the front surface 12A on the upper side Z2 with respect to the horizontal branch line 13 in front view. The operation section 21 is disposed on the front surface 12A of the housing 12 on the first width direction X1 side with respect to the vertical branch line 14 in front view.

The operation section 21 includes an operation panel 21B. The operation panel 21B is provided on the front surface 21A. The operation panel 21B can be operated by a user. That is, the operation section 21 can be operated by the user. The operation panel 21B can be operated by the user to input instructions related to the liquid discharge apparatus 11. The operation panel 21B can display information related to the liquid discharge apparatus 11.

The operation section 21 includes an upper end section 21C and a lower end section 21D. The operation section 21 is rotatable about an axis along the width direction X at the upper end section 21C. As a result, the operation section 21 is rotatable between a closed position at which the front surface 21A faces the front side Y1 as illustrated in FIG. 1 and an open position at which the front surface 21A faces the upper side Z2 as illustrated in FIG. 2.

The operation section 21 includes a first side end section 21E and a second side end section 21F. The first side end section 21E is a side end section on the first width direction X1 side. The second side end section 21F is a side end section on the second width direction X2 side.

The operation section 21 may include an operation grip section 21G. The first side end section 21E is provided. That is, the operation grip section 21G is provided on the first side surface 12B side of the operation section 21. The operation grip section 21G is provided on the lower end section 21D side.

The operation grip section 21G can be gripped by the user. The operation grip section 21G can be gripped by the user when the operation section 21 is rotated. The operation grip section 21G is provided at a position facing the recessed section 20A on the first side surface 12B side of the operation section 21. As described above, the operation grip section 21G is configured to grip the operation section 21.

The liquid discharge apparatus 11 includes a cover 22. The cover 22 includes a front surface 22A. The front surface 22A of the cover 22 constitutes a part of the front surface 12A of the housing 12. The cover 22 is disposed on the front surface 12A on the lower side Z1 with respect to the horizontal branch line 13 in front view. The cover 22 is provided to straddle a virtual line along the vertical branch line 14 in front view. That is, the cover 22 is provided to straddle the vertical branch line 14 in front view. The cover 22 is provided over the entire width in front view.

The cover 22 includes an upper end section 22B and a lower end section 22C. The cover 22 can be rotated about an axis along the width direction X at the lower end section 22C. As a result, the cover 22 is rotatable between a closed position at which the front surface 22A faces the front side Y1 as illustrated in FIG. 1 and an open position at which the front surface 22A faces the lower side Z1 as illustrated in FIG. 2.

The cover 22 includes a first side end section 22D and a second side end section 22E. The first side end section 22D is a side end section on the first width direction X1 side. The second side end section 22E is a side end section on the second width direction X2 side.

The cover 22 may include a cover grip section 22F. The cover grip section 22F is provided at the end section of the cover 22 in the first width direction X1. That is, the cover grip section 22F is provided on the first side surface 12B side of the cover 22. The cover grip section 22F is provided on the upper end section 22B side.

The cover grip section 22F can be gripped by the user. The cover grip section 22F can be gripped by the user when the cover 22 is rotated. The cover grip section 22F is provided at a position facing the recessed section 20A on the first side surface 12B side of the cover 22. As described above, the cover grip section 22F is configured to grip the cover 22.

The recessed section 20A is provided to face both the operation grip section 21G and the cover grip section 22F on the first side surface 12B side. As a result, the user can grip the operation section 21 and the cover 22 from the first side surface 12B side at the front.

The cover 22 includes a visual recognition region 22G. The visual recognition region 22G is a region provided at a position facing a liquid visual recognition section 26 to be described later in a state where the cover 22 is disposed at the closed position. The visual recognition region 22G is a region in which the liquid visual recognition section 26 to be described later can be visually recognized in front view in a state where the cover 22 is disposed at the closed position.

The visual recognition region 22G is a region in which at least a part of the liquid visual recognition section 26 described later can be visually recognized in front view in a state where the cover 22 is disposed at the closed position. The visual recognition region 22G is a region in which at least a visual recognition window 26B to be described later can be visually recognized in front view. The visual recognition region 22G has a larger size than the visual recognition window 26B to be described later.

The visual recognition region 22G may be an opening section. That is, the cover 22 may include an opening section as the visual recognition region 22G. As described above, the opening section may be provided at a position facing the liquid visual recognition section 26 to be described later in a state where the cover 22 is disposed at the closed position.

As illustrated in FIG. 2, the liquid discharge apparatus 11 includes a discharge port 23. The discharge port 23 is opened on the front side Y1 when the cover 22 is at the open position. The discharge port 23 is an opening for discharging the medium onto which liquid is discharged to the outside of the liquid discharge apparatus 11. That is, the discharge port 23 is an opening for discharging the medium after printing. As described above, the cover 22 can open and close the discharge port 23.

The liquid discharge apparatus 11 includes a discharge tray 24. The discharge tray 24 is provided on the lower side Z1 of the discharge port 23. The discharge tray 24 can slide along the front-rear direction Y. The discharge tray 24 can slide in a state of extending on the front side Y1 when the cover 22 is at the open position. The discharge tray 24 is configured to place the medium discharged from the discharge port 23. That is, a medium accommodation section 25 can place the medium after printing.

The liquid discharge apparatus 11 includes the medium accommodation section 25. The medium accommodation section 25 is provided on the lower side Z1 of the discharge tray 24 inside the housing main body 20. The medium accommodation section 25 can slide along the front-rear direction Y. The medium accommodation section 25 is slidable along the front-rear direction Y when the cover 22 is at the open position. The medium accommodation section 25 may be attachable to and detachable from the housing main body 20.

The medium accommodation section 25 can accommodate a medium for discharging liquid. That is, the medium accommodation section 25 can accommodate the medium before printing. The medium accommodation section 25 can accommodate the medium for discharging the liquid by sliding the medium accommodation section 25 to the front side Y1 when the cover 22 is at the open position. As described above, the cover 22 can open and close the medium accommodation section 25.

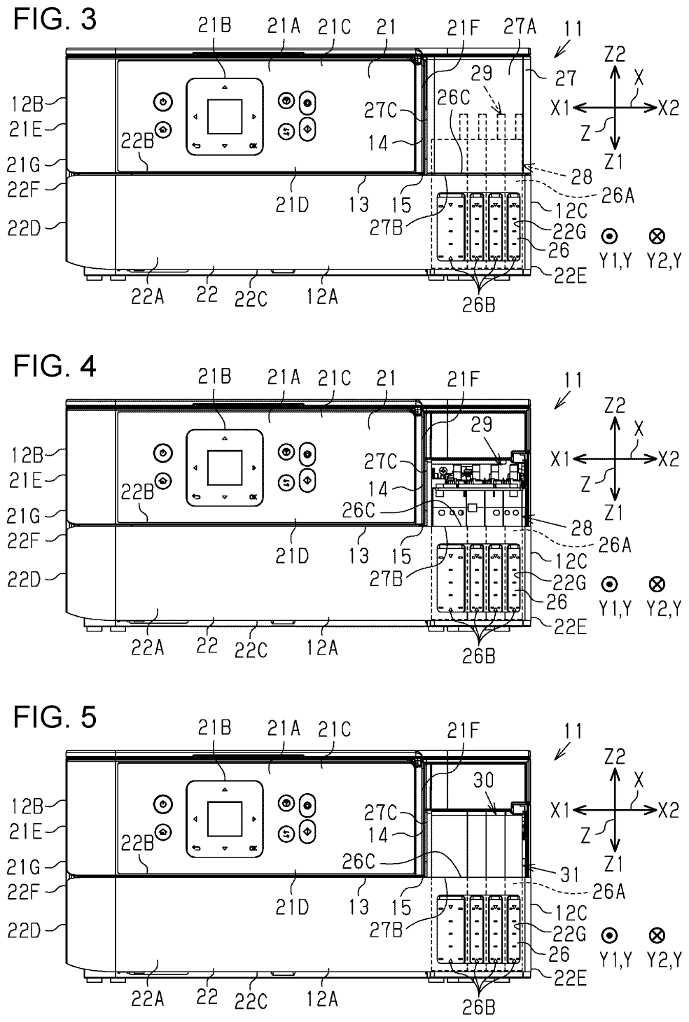

As illustrated in FIG. 3, the liquid discharge apparatus 11 includes a liquid visual recognition section 26. The liquid visual recognition section 26 includes a front surface 26A. The front surface 26A of the liquid visual recognition section 26 constitutes a part of the front surface 12A of the housing 12.

The liquid visual recognition section 26 is disposed on the front surface 12A on the lower side Z1 with respect to the horizontal branch line 13 in front view. The liquid visual recognition section 26 is disposed on the front surface 12A of the housing 12 on the second width direction X2 side with respect to the vertical branch line 14 in front view.

The liquid visual recognition section 26 is provided to visually recognize the remaining amount of the liquid accommodated in a liquid accommodation section 28 to be described later. That is, the liquid visual recognition section 26 is provided for visual recognition of the remaining amount of the liquid to be discharged onto the medium.

The liquid visual recognition section 26 includes a visual recognition window 26B. The liquid visual recognition section 26 may include a plurality of visual recognition windows 26B. The liquid visual recognition section 26 may include a plurality of visual recognition windows 26B to correspond to the type of liquid. The visual recognition window 26B is provided on the front surface 26A.

The visual recognition window 26B is disposed on the front surface 12A in the range of the lower side Z1 with respect to the horizontal branch line 13 in front view. The visual recognition window 26B is disposed on the front surface 12A of the housing 12 in a range on the second width direction X2 side with respect to the vertical branch line 14 in front view. Even in a state where the cover 22 is disposed at the closed position, at least the visual recognition window 26B can be visually recognized through the visual recognition region 22G.

The liquid discharge apparatus 11 includes an accommodation cover 27. The accommodation cover 27 includes a front surface 27A. The front surface 27A of the accommodation cover 27 constitutes a part of the front surface 12A of the housing 12. The accommodation cover 27 is disposed on the front surface 12A on the upper side Z2 with respect to the horizontal branch line 13 in front view. The accommodation cover 27 is disposed on the front surface 12A of the housing 12 on the second width direction X2 side with respect to the vertical branch line 14 in front view.

As illustrated in FIGS. 3 and 4, the accommodation cover 27 is attachable to and detachable from the housing main body 20. The accommodation cover 27 is configured to cover a part of the liquid accommodation section 28 described later when mounted on the housing main body 20. The accommodation cover 27 is configured to cover a liquid replenishment port 29 to be described later when mounted on the housing main body 20.

The liquid discharge apparatus 11 includes the liquid accommodation section 28. The liquid accommodation section 28 is configured to accommodate the liquid to be discharged onto the medium. The liquid accommodation section 28 may be, for example, an ink tank. The liquid accommodation section 28 is attached to the liquid discharge apparatus 11 not to be detachable from the liquid discharge apparatus 11, but may be detachable.

The liquid accommodation section 28 is disposed on the second width direction X2 side with respect to the vertical branch line 14 in front view. The liquid accommodation section 28 is provided to straddle the horizontal branch line 13 in the vertical direction Z in front view. As described above, the liquid accommodation section 28 is provided at a position aligned with the operation section 21 in the width direction X. The liquid accommodation section 28 is provided in the rear side Y2 of the cover 22 on the lower side Z1 with respect to the horizontal branch line 13.

The liquid accommodation section 28 is disposed on the rear side Y2 of the liquid visual recognition section 26. As a result, the remaining amount of the liquid accommodated in the liquid accommodation section 28 can be visually recognized by the user via the liquid visual recognition section 26.

The liquid accommodation section 28 is covered with the accommodation cover 27 when the accommodation cover 27 is mounted on the housing main body 20. When the accommodation cover 27 is detached from the housing main body 20, a part of the liquid accommodation section 28 is exposed on the upper side Z2.

The liquid accommodation section 28 includes the liquid replenishment port 29. That is, the liquid discharge apparatus 11 includes the liquid replenishment port 29. The liquid replenishment port 29 is an opening for replenishing the liquid accommodation section 28 with liquid.

The liquid replenishment port 29 is disposed on the second width direction X2 side with respect to the vertical branch line 14 in front view. The liquid replenishment port 29 is disposed on the upper side Z2 with respect to the horizontal branch line 13 in front view. That is, the liquid replenishment port 29 is provided in a range between the upper end section 21C and the lower end section 21D of the operation section 21 in the vertical direction Z.

The liquid replenishment port 29 is covered with the accommodation cover 27 when the accommodation cover 27 is mounted on the housing main body 20. The liquid replenishment port 29 is exposed when the accommodation cover 27 is detached from the housing main body 20.

As described above, the horizontal branch line 13 is configured with the lower end section 21D of the operation section 21, a lower end section 27B of the accommodation cover 27, and the upper end section 22B of the cover 22. When the cover 22 is at the open position, the horizontal branch line 13 is configured with the lower end section 27B of the accommodation cover 27 and the upper end section 26C of the liquid visual recognition section 26 on the second width direction X2 side with respect to the vertical branch line 14.

The vertical branch line 14 is configured with the second side end section 21F of the operation section 21 and the side end section 27C of the accommodation cover 27 in the first width direction X1.

### Operation and Effects of First Embodiment

The operation and effects of the first embodiment will be described.
1-1. The operation section 21 is disposed on the first width direction X1 side with respect to the vertical branch line 14 in front view, and the liquid accommodation section 28, the liquid replenishment port 29, and the liquid visual recognition section 26 are disposed on the second width direction X2 side with respect to the vertical branch line 14 in front view. According to this configuration, in front view, the vertical branch line 14 can divide the region into a region in which the operation section 21 is disposed and a region in which the liquid accommodation section 28, the liquid replenishment port 29, and the liquid visual recognition section 26 are disposed. Therefore, the quality of the appearance of the front surface 12A of the liquid discharge apparatus 11 can be improved.
1-2. The liquid accommodation section 28 is provided at a position aligned with the operation section 21 in the width direction X. The liquid replenishment port 29 is provided in a range between the upper end section 21C and the lower end section 21D of the operation section 21 in the vertical direction Z. The liquid visual recognition section 26 is provided in a range on the lower side Z1 with respect to the lower end section 21D of the operation section 21 in the vertical direction Z. According to this configuration, the liquid accommodation section 28, the liquid replenishment port 29, and the liquid visual recognition section 26 can be disposed with the operation section 21 as a reference on the second width direction X2 side of the operation section 21. Therefore, the quality of the appearance of the front surface 12A of the liquid discharge apparatus 11 can be improved.
1-3. The cover grip section 22F is provided on the first side surface 12B side. According to this configuration, the cover grip section 22F can be disposed at a position that is difficult to be visually recognized on the front surface 12A of the liquid discharge apparatus 11. Thus, the convenience of the user can be improved and the quality of the appearance on the front surface 12A of the liquid discharge apparatus 11 can be improved.
1-4. The operation grip section 21G is provided on the first side surface 12B side. According to this configuration, the operation grip section 21G can be disposed at a position that is difficult to be visually recognized on the front surface 12A of the liquid discharge apparatus 11. Thus, the convenience of the user can be improved and the quality of the appearance on the front surface 12A of the liquid discharge apparatus 11 can be improved.
1-5. The recessed section 20A is provided on the first side surface 12B to face both the cover grip section 22F and the operation grip section 21G. According to this configuration, the recessed section 20A can provide the user with a situation in which it is easy to grip the cover grip section 22F and the operation grip section 21G, respectively. In addition, the recessed section 20A can be disposed at a position that is difficult to be visually recognized on the front surface 12A of the liquid discharge apparatus 11. Thus, the convenience of the user can be improved and the quality of the appearance on the front surface 12A of the liquid discharge apparatus 11 can be improved.
1-6. The cover 22 is rotatable about an axis along the width direction X at the lower end section 22C. The operation section 21 is rotatable about an axis along the width direction X at the upper end section 21C. The cover grip section 22F is provided on the upper end section 22B side of the cover 22. The operation grip section 21G is provided on the lower end section 21D side of the operation section 21. According to this configuration, the cover grip section 22F and the operation grip section 21G can be provided at positions close to each other on the first side surface 12B side with respect to the vertical branch line 14 in the width direction X. This provides the user with a situation in which it is easy to grip the cover grip section 22F and the operation grip section 21G, respectively. In addition, the cover grip section 22F and the operation grip section 21G can be disposed at a position that is difficult to be visually recognized on the front surface 12A of the liquid discharge apparatus 11. Thus, the convenience of the user can be improved and the quality of the appearance on the front surface 12A of the liquid discharge apparatus 11 can be improved.
1-7. The operation section 21 is disposed on the upper side Z2 with respect to the horizontal branch line 13 in front view, and the cover 22 is disposed on the lower side Z1 with respect to the horizontal branch line 13. According to this configuration, in front view, the horizontal branch line 13 can divide the region into a region in which the operation section 21 is disposed and a region in which the cover 22 is disposed. Therefore, the quality of the appearance of the front surface 12A of the liquid discharge apparatus 11 can be improved.
1-8. The lower end section 21D of the operation section 21 and the upper end section 22B of the cover 22 constitute the horizontal branch line 13. According to this configuration, in front view, the horizontal branch line 13 can be provided by the lower end section 21D of the operation section 21 and the upper end section 22B of the cover 22. Therefore, the quality of the appearance of the front surface 12A of the liquid discharge apparatus 11 can be improved.
1-9. The cover 22 can open and close the medium accommodation section 25. According to this configuration, the medium accommodation section 25 can be opened and closed by the cover 22. As a result, the convenience of the user can be improved.
1-10. The cover 22 is rotatable between an open position for opening the discharge port 23 and a closed position for closing the discharge port 23. The cover 22 has the visual recognition region 22G in a state of being disposed at the closed position, at a position facing the liquid visual recognition section 26, at which the liquid visual recognition section 26 is visually recognized. According to this configuration, the liquid visual recognition section 26 can be visually recognized through the visual recognition region 22G even in a state where the cover 22 is disposed at the closed position. Thus, the convenience of the user can be improved and the quality of the appearance on the front surface 12A of the liquid discharge apparatus 11 can be improved.

### Second Embodiment

Next, a second embodiment will be described. In the following description, overlapping descriptions will be omitted or simplified for the same configurations as the embodiments already described, and configurations different from the embodiments already described will be described.

As illustrated in FIG. 5, in the second embodiment, the liquid discharge apparatus 11 includes a mounting section 30 instead of the liquid accommodation section 28. The liquid discharge apparatus 11 may include a plurality of mounting sections 30. The liquid discharge apparatus 11 may include a plurality of mounting sections 30 to correspond to the type of liquid.

The mounting section 30 is attachable to and detachable from the liquid accommodation container 31. That is, the liquid accommodation container 31 can be mounted on the mounting section 30. The mounting section 30 is disposed on the second width direction X2 side with respect to the vertical branch line 14 in front view.

The liquid accommodation container 31 is a container that accommodates a liquid to be discharged onto a medium. The liquid accommodation container 31 may be, for example, an ink cartridge. The liquid accommodation container 31 can be mounted on the mounting section 30.

When the liquid accommodation container 31 is mounted on the mounting section 30, the liquid accommodation container 31 is disposed on the second width direction X2 side with respect to the vertical branch line 14 in front view. The liquid accommodation container 31 is provided to straddle the horizontal branch line 13 in front view when mounted on the mounting section 30. As described above, the liquid accommodation container 31 is provided at a position aligned with the operation section 21 in the width direction X when mounted on the mounting section 30. The liquid accommodation container 31 is provided at a position aligned with the cover 22 in the width direction X when mounted on the mounting section 30.

The liquid accommodation container 31 is disposed on the rear side Y2 of the liquid visual recognition section 26 when mounted on the mounting section 30. The liquid visual recognition section 26 is provided for visual recognition of the remaining amount of the liquid accommodated in the liquid accommodation container 31. As a result, the remaining amount of the liquid accommodated in the liquid accommodation container 31 can be visually recognized by the user via the liquid visual recognition section 26.

### Operation and Effects of Second Embodiment

The operation and effects of the second embodiment will be described.
2-1. The operation section 21 is disposed on the first width direction X1 side with respect to the vertical branch line 14 in front view, and the liquid accommodation container 31 and the liquid visual recognition section 26 mounted on the mounting section 30 are disposed on the second width direction X2 side with respect to the vertical branch line 14 in front view. According to this configuration, in front view, the vertical branch line 14 can divide the region into a region in which the operation section 21 is disposed and a region in which the liquid accommodation container 31 mounted on the mounting section 30 and the liquid visual recognition section 26 are disposed. Therefore, the quality of the appearance of the front surface 12A of the liquid discharge apparatus 11 can be improved.
2-2. The liquid accommodation container 31 mounted on the mounting section 30 is provided at a position aligned with the operation section 21 in the width direction X. The liquid visual recognition section 26 is provided in a range on the lower side Z1 with respect to the lower end section 21D of the operation section 21 in the vertical direction Z. According to this configuration, the liquid accommodation container 31 and the liquid visual recognition section 26 mounted on the mounting section 30 can be disposed with the operation section 21 as a reference in the second width direction X2 side of the operation section 21. Therefore, the quality of the appearance of the front surface 12A of the liquid discharge apparatus 11 can be improved.

### Modification Example

The present embodiment can be modified and implemented as follows. The present embodiment and the following modification example can be implemented in combination with each other unless there is a technical contradiction.
In the first embodiment, the liquid accommodation section 28 may be disposed on the lower side Z1 with respect to the horizontal branch line 13 without straddling the horizontal branch line 13. The liquid accommodation section 28 may be disposed on the upper side Z2 with respect to the horizontal branch line 13 without straddling the horizontal branch line 13.
In the second embodiment, when the liquid accommodation container 31 is mounted on the mounting section 30, the liquid accommodation container 31 may be disposed on the lower side Z1 with respect to the horizontal branch line 13 without straddling the horizontal branch line 13. When the liquid accommodation container 31 is mounted on the mounting section 30, the liquid accommodation container 31 may be disposed on the upper side Z2 with respect to the horizontal branch line 13 without straddling the horizontal branch line 13.
In the second embodiment, the mounting sections 30 may be disposed to straddle the horizontal branch line 13. The mounting section 30 may be disposed on the lower side Z1 with respect to the horizontal branch line 13 without straddling the horizontal branch line 13. The mounting section 30 may be disposed the upper side Z2 with respect to the horizontal branch line 13 without straddling the horizontal branch line 13.
The visual recognition region 22G may be a light-transmitting region having light-transmitting properties. That is, the cover 22 may have a light-transmitting region as the visual recognition region 22G. In the light-transmitting region, a light-transmitting member having light-transmitting properties may be disposed in the opening section. The cover 22 may not have an opening section and may not be subjected to a light shielding process in the light-transmitting region.

According to this configuration, the liquid visual recognition section 26 can be visually recognized through the light-transmitting region even in a state where the cover 22 is disposed at the closed position. Thus, the convenience of the user can be improved and the quality of the appearance on the front surface 12A of the liquid discharge apparatus 11 can be improved.
The cover grip section 22F may be provided on the second side surface 12C side. The cover grip section 22F may be provided on both the first side surface 12B side and the second side surface 12C side. That is, the cover grip section 22F may be provided on at least one of the first side surface 12B side and the second side surface 12C side.
When the cover grip section 22F is provided on the second side surface 12C side, the housing main body 20 may include the recessed section 20A facing the cover grip section 22F on the second side surface 12C. That is, when the cover grip section 22F is provided on at least the first side surface 12B side, the housing main body 20 may include the recessed section 20A facing both the cover grip section 22F and the operation grip section 21G on the first side surface 12B.
The liquid discharge apparatus 11 may include an operation drive section for rotating the operation section 21 and a control section that controls the operation drive section. The control section may be configured with at least one computer, and may include at least one processor and at least one memory. The control section controls the operation drive section to rotate the operation section 21. The control section may control the operation drive section to rotate the operation section 21 in response to an instruction from the user.
The liquid discharge apparatus 11 may include a cover drive section for rotating the cover 22 and a control section that controls the cover drive section. The control section controls the cover drive section to rotate the cover 22. The control section may control the cover drive section to rotate the cover 22 in response to an instruction from the user.
The operation grip section 21G may be provided on the upper end section 21C side. The operation grip section 21G may be provided between the upper end section 21C and the lower end section 21D. The operation grip section 21G may be provided at a position that does not face the recessed section 20A.
The cover grip section 22F may be provided on the lower end section 22C side. The cover grip section 22F may be provided between the upper end section 22B and the lower end section 22C. The cover grip section 22F may be provided at a position that does not face the recessed section 20A.
The housing main body 20 may include a plurality of recessed sections 20A. The recessed section 20A may be provided at both a position facing the operation grip section 21G and a position facing the cover grip section 22F. The housing main body 20 may not include the plurality of recessed sections 20A.
The operation section 21 may be rotatable about an axis along the width direction X at the lower end section 21D. The operation section 21 may be rotatable about an axis along the vertical direction Z at the second side end section 21F. The operation section 21 may be rotatable about an axis along the vertical direction Z at the first side end section 21E. The operation section 21 may move to slide instead of rotating. The operation section 21 may not move to be opened and closed.
The cover 22 may be rotatable about an axis along the width direction X at the upper end section 22B. The cover 22 may be rotatable about an axis along the vertical direction Z at the second side end section 22E. The cover 22 may be rotatable about an axis along the vertical direction Z at the first side end section 22D. The cover 22 may move to slide instead of rotating. The cover 22 may not move to be opened and closed.
The cover 22 may function as the discharge tray 24 by being disposed at the open position. Thereby, an increase in the size of the liquid discharge apparatus 11 can be suppressed. The cover 22 may be configured so that at least one of the discharge port 23, the discharge tray 24, and the medium accommodation section 25 is not open to the front side Y1.
The distance between the members constituting the horizontal branch line 13 may be any distance. That is, the thickness of the horizontal branch line 13 may be any thickness. The distance between the members constituting the vertical branch line 14 may be any distance. That is, the thickness of the vertical branch line 14 may be any thickness.
The front surface 12A may be provided with another branch line along the width direction X other than the horizontal branch line 13. The front surface 12A may be provided with another branch line along the vertical direction Z other than the vertical branch line 14.
The medium may be a resin film or sheet, a composite film of resin and metal, a laminate film, a woven fabric, a non-woven fabric, a metal foil, a metal film, a ceramic sheet, clothing, or the like.
The liquid can be optionally selected as long as the liquid can be printed on the medium by adhering to the medium. For example, ink includes those in which particles of functional materials made of solid substances such as pigments and metal particles are dissolved, dispersed, or mixed in a solvent, and includes various compositions such as water-based ink, oil-based ink, gel ink, and hot melt ink.
The liquid discharge apparatus 11 may be mounted on a multifunction device together with an image reading apparatus. The image reading apparatus is configured to read an image from an original document. In such a case, a reading cover (not illustrated) configured to be opened and closed with respect to the housing main body 20 may be provided. A horizontal branch line formed by a reading cover may be provided on the front surface 12A of the housing 12.
The expression “at least one” used in the present specification means one or more of desired options. As an example, the expression “at least one” used in the present specification means only one option or both of two options when the number of options is two. In another example, the expression “at least one” used in the present specification means only one option or a combination of any two or more options when the number of options is three or more.

### Additional Notes

Hereinafter, the technical ideas and the operational effects understood from the above-described embodiment and modification example will be described. The technical idea and the operational effect of the present disclosure can be combined with each other in a technically consistent range.
1. A liquid discharge apparatus includes a liquid accommodation section that accommodates liquid to be discharged onto a medium, a liquid replenishment port for replenishing liquid into the liquid accommodation section, a liquid visual recognition section that visually recognizes a remaining amount of the liquid accommodated in the liquid accommodation section, an operation section that is operable by a user, a discharge port for discharging the medium onto which the liquid is discharged, a cover configured to open and close the discharge port, and a cover grip section configured to grip the cover, in which the operation section is disposed on one side in a width direction intersecting a vertical direction with respect to a vertical branch line extending along the vertical direction in front view, the liquid accommodation section, the liquid replenishment port, and the liquid visual recognition section are disposed on another side in the width direction with respect to the vertical branch line in front view, the liquid accommodation section is provided at a position aligned with the operation section in the width direction, the liquid replenishment port is provided in a range between an upper end section and a lower end section of the operation section in the vertical direction, the liquid visual recognition section is provided in a range below the lower end section of the operation section in the vertical direction, the cover is provided to straddle the vertical branch line and is rotatable about an axis along the width direction, and the cover grip section is provided on at least one of a first side surface side on the one side in the width direction with respect to the vertical branch line, and a second side surface on the other side in the width direction with respect to the vertical branch line.

According to this configuration, in front view, the vertical branch line can divide the region into a region in which the operation section is disposed and a region in which the liquid accommodation section, the liquid replenishment port, and the liquid visual recognition section are disposed. Therefore, the quality of the appearance of the front surface of the liquid discharge apparatus can be improved.

The liquid accommodation section, the liquid replenishment port, and the liquid visual recognition section can be disposed with the operation section as a reference on the other side of the operation section in the width direction. Therefore, the quality of the appearance of the front surface of the liquid discharge apparatus can be improved.

A cover grip section for rotating the cover about an axis along the width direction is provided on at least one of the first side surface side on one side and the second side surface on the other side of the vertical branch line in the width direction. As a result, the cover grip section can be disposed at a position that is difficult to be visually recognized on the front surface of the liquid discharge apparatus. Therefore, the convenience of the user can be improved and the quality of the appearance on the front surface of the liquid discharge apparatus can be improved.
2. A liquid discharge apparatus includes a mounting section that mounts a liquid accommodation container for accommodating liquid to be discharged onto a medium, a liquid visual recognition section that visually recognizes a remaining amount of the liquid accommodated in the liquid accommodation container, an operation section that is operable by a user, a discharge port for discharging the medium onto which the liquid is discharged, a cover configured to open and close the discharge port, and a cover grip section configured to grip the cover, in which the operation section is disposed on one side in a width direction intersecting a vertical direction with respect to a vertical branch line extending along the vertical direction in front view, when the liquid accommodation container is mounted on the mounting section, the liquid accommodation container and the liquid visual recognition section are disposed on another side in the width direction with respect to the vertical branch line in front view, when the liquid accommodation container is mounted on the mounting section, the liquid accommodation container is provided at a position aligned with the operation section in the width direction, the liquid visual recognition section is provided in a range below a lower end section of the operation section in the vertical direction, the cover is provided to straddle the vertical branch line and is rotatable about an axis along the width direction, and the cover grip section is provided on at least one of a first side surface side on the one side in the width direction with respect to the vertical branch line, and a second side surface on the other side in the width direction with respect to the vertical branch line.

According to this configuration, in front view, the vertical branch line can divide the region into a region in which the operation section is disposed and a region in which the liquid accommodation container mounted on the mounting section and the liquid visual recognition section are disposed. Therefore, the quality of the appearance of the front surface of the liquid discharge apparatus can be improved.

The liquid accommodation container and the liquid visual recognition section mounted on the mounting section can be disposed with the operation section as a reference on the other side of the operation section in the width direction. Therefore, the quality of the appearance of the front surface of the liquid discharge apparatus can be improved.

A cover grip section for rotating the cover about an axis along the width direction is provided on at least one of the first side surface side on one side and the second side surface on the other side of the vertical branch line in the width direction. As a result, the cover grip section can be disposed at a position that is difficult to be visually recognized on the front surface of the liquid discharge apparatus. Therefore, the convenience of the user can be improved and the quality of the appearance on the front surface of the liquid discharge apparatus can be improved.
3. In the liquid discharge apparatus, the cover may be rotatable between an open position for opening the discharge port and a closed position for closing the discharge port, and in a state of being disposed at the closed position, may have a visual recognition region for visually recognizing the liquid visual recognition section at a position facing the liquid visual recognition section.

According to this configuration, the liquid visual recognition section can be visually recognized through the visual recognition region even in a state where the cover is disposed at the closed position. Therefore, the convenience of the user can be improved and the quality of the appearance on the front surface of the liquid discharge apparatus can be improved.
4. In the liquid discharge apparatus, the cover may have an opening section as the visual recognition region.

According to this configuration, the liquid visual recognition section can be visually recognized through the opening section even in a state where the cover is disposed at the closed position. Therefore, the convenience of the user can be improved and the quality of the appearance on the front surface of the liquid discharge apparatus can be improved.
5. In the liquid discharge apparatus, the cover may have a light-transmitting region as the visual recognition region.

According to this configuration, the liquid visual recognition section can be visually recognized through the light-transmitting region even in a state where the cover is disposed at the closed position. Therefore, the convenience of the user can be improved and the quality of the appearance on the front surface of the liquid discharge apparatus can be improved.
6. The liquid discharge apparatus may further include an operation grip section configured to grip the operation section, in which the operation section may be rotatable about an axis along the width direction, and the operation grip section may be provided on the first side surface side.

According to this configuration, the operation grip section for rotating the operation section about the axis along the width direction is provided on the first side surface side on one side with respect to the vertical branch line in the width direction. As a result, the operation grip section can be disposed at a position that is difficult to be visually recognized on the front surface of the liquid discharge apparatus. Therefore, the convenience of the user can be improved and the quality of the appearance on the front surface of the liquid discharge apparatus can be improved.
7. In the liquid discharge apparatus, when the cover grip section is provided on at least the first side surface side, the first side surface may be provided with a recessed section facing both the cover grip section and the operation grip section.

According to this configuration, the recessed section can provide the user with a situation in which it is easy to grip the cover grip section and the operation grip section, respectively. In addition, the recessed section can be disposed at a position that is difficult to be visually recognized on the front surface of the liquid discharge apparatus. Therefore, the convenience of the user can be improved and the quality of the appearance on the front surface of the liquid discharge apparatus can be improved.
8. In the liquid discharge apparatus, the cover may be rotatable about the axis along the width direction at a lower end section, the operation section may be rotatable about the axis along the width direction at an upper end section, the cover grip section may be provided on an upper end section side of the cover in the vertical direction, and the operation grip section may be provided on a lower end section side of the operation section in the vertical direction.

According to this configuration, the cover grip section and the operation grip section can be provided at positions close to each other on the first side surface side with respect to the vertical branch line in the width direction. This can provide the user with a situation in which it is easy to grip the cover grip section and the operation grip section, respectively. In addition, the cover grip section and the operation grip section can be disposed at a position that is difficult to be visually recognized on the front surface of the liquid discharge apparatus. Therefore, the convenience of the user can be improved and the quality of the appearance on the front surface of the liquid discharge apparatus can be improved.
9. In the liquid discharge apparatus, the operation section may be disposed above a horizontal branch line extending along the width direction in front view, and the cover may be disposed below the horizontal branch line.

According to this configuration, in front view, the horizontal branch line can divide the region into a region in which the operation section is disposed and a region in which the cover is disposed. Therefore, the quality of the appearance of the front surface of the liquid discharge apparatus can be improved.
10. In the liquid discharge apparatus, the lower end section of the operation section and an upper end section of the cover may constitute the horizontal branch line.

According to this configuration, the horizontal branch line can be provided by the lower end section of the operation section and the upper end section of the cover in front view. Therefore, the quality of the appearance of the front surface of the liquid discharge apparatus can be improved.
11. The liquid discharge apparatus may further include a medium accommodation section that accommodates a medium onto which liquid is discharged, in which the cover may be configured to open and close the medium accommodation section.

According to this configuration, the medium accommodation section can be opened and closed by the cover. As a result, the convenience of the user can be improved.

What is claimed is:

1. A liquid discharge apparatus comprising:
a liquid accommodation section that accommodates liquid to be discharged onto a medium;
a liquid replenishment port for replenishing liquid into the liquid accommodation section;
a liquid visual recognition section that visually recognizes a remaining amount of the liquid accommodated in the liquid accommodation section;
an operation section that is operable by a user;
a discharge port for discharging the medium onto which the liquid is discharged;
a cover configured to open and close the discharge port; and
a cover grip section configured to grip the cover, wherein
the operation section is disposed on one side in a width direction intersecting a vertical direction with respect to a vertical branch line extending along the vertical direction in front view,
the liquid accommodation section, the liquid replenishment port, and the liquid visual recognition section are disposed on another side in the width direction with respect to the vertical branch line in front view,
the liquid accommodation section is provided at a position aligned with the operation section in the width direction,
the liquid replenishment port is provided in a range between an upper end section and a lower end section of the operation section in the vertical direction,
the liquid visual recognition section is provided in a range below the lower end section of the operation section in the vertical direction,
the cover is provided to straddle the vertical branch line and is rotatable about an axis along the width direction, and
the cover grip section is provided on at least one of a first side surface side on the one side in the width direction with respect to the vertical branch line, and a second side surface on the other side in the width direction with respect to the vertical branch line.

2. A liquid discharge apparatus comprising:
a mounting section that mounts a liquid accommodation container for accommodating liquid to be discharged onto a medium;
a liquid visual recognition section that visually recognizes a remaining amount of the liquid accommodated in the liquid accommodation container;
an operation section that is operable by a user;
a discharge port for discharging the medium onto which the liquid is discharged;
a cover configured to open and close the discharge port; and
a cover grip section configured to grip the cover, wherein
the operation section is disposed on one side in a width direction intersecting a vertical direction with respect to a vertical branch line extending along the vertical direction in front view,
when the liquid accommodation container is mounted on the mounting section, the liquid accommodation container and the liquid visual recognition section are disposed on another side in the width direction with respect to the vertical branch line in front view,
when the liquid accommodation container is mounted on the mounting section, the liquid accommodation container is provided at a position aligned with the operation section in the width direction,
the liquid visual recognition section is provided in a range below a lower end section of the operation section in the vertical direction,
the cover is provided to straddle the vertical branch line and is rotatable about an axis along the width direction, and
the cover grip section is provided on at least one of a first side surface side on the one side in the width direction with respect to the vertical branch line, and a second side surface on the other side in the width direction with respect to the vertical branch line.

3. The liquid discharge apparatus according to claim 1, wherein
the cover is rotatable between an open position for opening the discharge port and a closed position for closing the discharge port, and
in a state of being disposed at the closed position, the cover has a visual recognition region for visually recognizing the liquid visual recognition section at a position facing the liquid visual recognition section.

4. The liquid discharge apparatus according to claim 3, wherein
the cover has an opening section as the visual recognition region.

5. The liquid discharge apparatus according to claim 3, wherein
the cover has a light-transmitting region as the visual recognition region.

6. The liquid discharge apparatus according to claim 1, further comprising:
an operation grip section configured to grip the operation section, wherein the operation section is rotatable about an axis along the width direction, and
the operation grip section is provided on the first side surface side.

7. The liquid discharge apparatus according to claim 6, wherein
when the cover grip section is provided on at least the first side surface side, the first side surface is provided with a recessed section facing both the cover grip section and the operation grip section.

8. The liquid discharge apparatus according to claim 7, wherein
the cover is rotatable about the axis along the width direction at a lower end section,
the operation section is rotatable about the axis along the width direction at an upper end section,
the cover grip section is provided on an upper end section side of the cover in the vertical direction, and
the operation grip section is provided on a lower end section side of the operation section in the vertical direction.

9. The liquid discharge apparatus according to claim 1, wherein
the operation section is disposed above a horizontal branch line extending along the width direction in front view, and
the cover is disposed below the horizontal branch line.

10. The liquid discharge apparatus according to claim 9, wherein
the lower end section of the operation section and an upper end section of the cover constitute the horizontal branch line.

11. The liquid discharge apparatus according to claim 1, further comprising:
a medium accommodation section that accommodates a medium onto which liquid is discharged, wherein
the cover is configured to open and close the medium accommodation section.
